(19) United States
(12) Patent Application Publication
(10) Pub. No.: US 2025/0281352 A1
(43) Pub. Date: Sep. 11, 2025

(54) MULTIFUNCTIONAL WAIST PHYSIOTHERAPY INSTRUMENT

(71) Applicant: Shenzhen Osto Medical Technology Co., LTD, Shenzhen (CN)

(72) Inventor: Yang Li, Shenzhen (CN)

(21) Appl. No.: 19/014,190

(22) Filed: Jan. 8, 2025

(30) Foreign Application Priority Data
Mar. 5, 2024 (CN) 202420430995.4

(51) Int. Cl. A61H 23/02

(52) U.S. Cl. CPC A61H 23/0263; A61H 2023/0272; A61H 2201/0103; A61H 2201/0207; A61H 2201/0228; A61H 2201/1215; A61H 2201/165; A61H 2201/1657; A61H 2201/5007; A61H 2201/5023; A61H 2205/083

(57) ABSTRACT

Disclosed is a multifunctional waist physiotherapy instrument, including: a housing, where a mounting cavity is arranged inside the housing; a control panel, a battery, a first motor, and a second motor that are fixedly arranged inside the mounting cavity, where the battery, the first motor and the second motor are respectively electrically connected to the control panel; heating sheets arranged on a top surface of the housing, and conductive adhesives mounted on the heating sheets, where the heating sheets are electrically connected to the control panel; an airbag fixing plate and an airbag pressing plate mounted on a back face of the housing, at least two traction airbags arranged between the airbag fixing plate and the airbag pressing plate, and an air pump arranged inside the mounting cavity, where the air pump is electrically connected to the control panel, and the traction airbags are connected to the air pump.

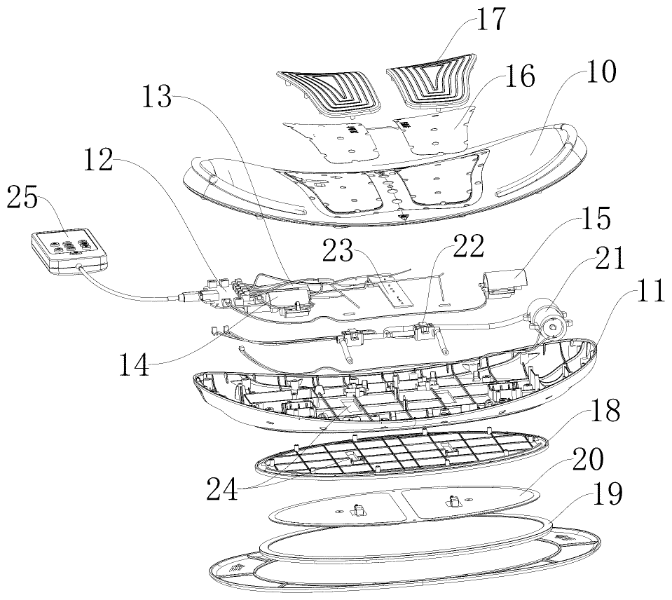

### CROSS REFERENCE TO RELATED APPLICATIONS

The present application claims the benefit of Chinese Patent Application No. 202420430995.4 filed on Mar. 5, 2024, the contents of which are incorporated herein by reference in their entirety.

### TECHNICAL FIELD

The present disclosure relates to the technical field of physiotherapy equipment, and in particular to a multifunctional waist physiotherapy instrument.

### BACKGROUND

Waist physiotherapy instruments are mainly used for physiotherapy of human waists, and are commonly used in daily life. For example, the patent with the application No. 201621380961.0 discloses a multifunctional physiotherapy waist pad. The waist pad includes two silicone pads that can be interconnected to form an accommodating cavity, data lines are arranged on the silicone pads in a penetrating manner, one end of the data line extends into the accommodating cavity, and a heating wire, a temperature sensor, a pulse output line, and a pulse receiving line respectively extend out, where the temperature sensor is closely attached to the heating wire, the heating wire is coiled by one circle in the accommodating cavity before being reconnected to the data line, and an electric heating switch is arranged at one end of reconnecting the heating wire to the data line. A plurality of pulse electrode plates are fixed inside the accommodating cavity, the pulse input line is divided into three strands after extending out from the data line, and each of the three strands is connected to one of the pulse electrode plates. Also, the pulse output line is divided into three strands after extending out from the data line, and each of the three strands is connected to one of the pulse electrode plates. Although having functions of heating, pulse therapy and the like, the multifunctional physiotherapy waist pad still cannot meet various needs due to lack of functional diversity.

Therefore, it is urgent to design a multifunctional waist physiotherapy instrument to overcome the above one or more defects in the prior art.

### SUMMARY

The technical solution adopted by the present disclosure to solve its technical problems is as follows: a multifunctional waist physiotherapy instrument, including: a housing, where a mounting cavity is arranged inside the housing, and a surface of the housing is arranged to be arc-shaped to adapt to a human waist; a control panel, a battery, a first motor, and a second motor that are fixedly arranged inside the mounting cavity, where the battery is electrically connected to the control panel, and the first motor and the second motor are respectively electrically connected to the control panel;

heating sheets arranged on an arc-shaped surface of the housing, and conductive adhesives mounted on the heating sheets, where the heating sheets are electrically connected to the control panel; and

an airbag fixing plate and an airbag pressing plate mounted on a surface of the housing opposite to the heating sheets, at least two traction airbags arranged between the airbag fixing plate and the airbag pressing plate, and an air pump further arranged inside the mounting cavity, where the air pump is electrically connected to the control panel, and the two traction airbags are connected to the air pump.

In a preferred example, a lamp panel is further arranged inside the mounting cavity, the lamp panel is electrically connected to the control panel, a plurality of LED lamps are arranged on the lamp panel, and lamp holes are formed in a surface of the housing corresponding to the lamp panel.

In a preferred example, avoidance holes are formed in a back face of the housing and the airbag fixing plate respectively, an air valve is further arranged inside the mounting cavity, the two traction airbags are respectively connected to the corresponding air valves through the avoidance holes, and the air valve is connected to the air pump.

In a preferred example, output ends of both the first motor and the second motor are connected to eccentric wheels.

In a preferred example, the control panel is further connected to a controller.

The present disclosure has the beneficial effects as follows: the physiotherapy instrument achieves a function of vibration massage through arrangement of the first motor and the second motor, achieves effects of massage based on the thermal therapy and pulsing through arrangement of the heating sheets and the conductive adhesive, and enhances the user experience through arrangement of the traction airbags, as a traction effect is generated during inflation and deflation. The present disclosure has a reasonably designed structure and diversified functions, and effectively meets different usage needs.

### BRIEF DESCRIPTION OF THE DRAWINGS

The sole FIGURE is an exploded view of the present disclosure.

### REFERENCE NUMERALS IN THE FIGURES

10. face housing; 11. bottom housing; 12. control panel; 13. battery; 14. first motor; 15. second motor; 16. heating sheet; 17. conductive adhesive; 18. airbag fixing plate; 19. airbag pressing plate; 20. traction airbag; 21. air pump; 22. air valve; 23. lamp panel; 24. avoidance hole; and 25. controller.

### DETAILED DESCRIPTIONS OF THE EMBODIMENTS

In order to enable the objectives, features, and advantages mentioned above of the present disclosure to be more apparent and easily understood, specific embodiments of the present disclosure will be described in detail below with reference to the accompanying drawings. Numerous specific details are set forth in the following description to facilitate a thorough understanding of the present disclosure. However, the present disclosure can be practiced in many other ways than those described herein, and those skilled in the art may make similar modifications without departing from the spirit of the present disclosure, and therefore the present disclosure is not to be limited by the specific examples disclosed below.

In the description of the examples of the present disclosure, it should be noted that, unless otherwise explicitly specified and defined, the terms “connection” and “mounting” should be understood in a broad sense. For example, “connection” may be a detachable connection, a non-detachable connection; and may be a direct connection, or an indirect connection via an intermediate medium. Further, “communication” may be a direct communication or an indirect communication via an intermediate medium. The term “fixed” refers to an interconnection where the relative positional relationship remains unchanged after the connection. The orientation terms mentioned in the present disclosure, such as “inside”, “outside”, “top”, “bottom” and the like, only indicate the directions in the accompanying drawings. Therefore, the orientation terms are used to better illustrate and understand the examples of the present disclosure, and are not intended to indicate or imply that the referenced device or element must have a particular orientation and be constructed and operative in a particular orientation, and thus may not be construed as a limitation on the examples of the present disclosure.

In the examples of the present disclosure, the terms “first” and “second” are only used for descriptive purposes, and should not be construed as indicating or implying relative importance or implicitly indicating the number of technical features indicated. Thus, a feature defined with “first” and “second” may explicitly or implicitly include one or more of the features.

In the examples of the present disclosure, the term “and/or”, which is merely an association relation describing an associated object, means that there may be three relations, for example, A and/or B may represent three situations: A exists alone, A and B exist at the same time, and B exists alone. In addition, the character “/” in the description generally indicates that successive association objects are in an “or” relation.

In the present specification, the description of reference terms such as “one example” and “some examples” means that specific features, structures or characteristics described in combination with this embodiment are included in one or more examples of the present disclosure. Therefore, the statements appearing in different parts of the present specification, such as “in one example”, “in some examples”, “in other examples”, “in some other examples” and the like, do not necessarily refer to the same embodiment, but mean “one or more, but not all examples”, unless otherwise specifically emphasized in any other way. The terms “including”, “containing”, “having” and any variations thereof mean “including but not limited to”, unless otherwise specifically emphasized in any other way. Therefore, the present disclosure is not to be limited by the specific examples disclosed below.

As illustrated in the sole FIGURE, the present disclosure provides a multifunctional waist physiotherapy instrument, and the physiotherapy instrument includes: a housing, where a mounting cavity is arranged inside the housing, and a surface of the housing is arranged to be arc-shaped to adapt to a human waist; a control panel 12, a battery 13, a first motor 14, and a second motor 15 that are fixedly arranged inside the mounting cavity, where the battery 13 is electrically connected to the control panel 12, and the first motor 14 and the second motor 15 are respectively electrically connected to the control panel 12;
heating sheets 16 arranged on the arc-shaped surface of the housing, and conductive adhesives 17 mounted on the heating sheets 16, where the heating sheets 16 are electrically connected to the control panel 12;
an airbag fixing plate 18 and an airbag pressing plate 19 mounted on a surface of the housing opposite to the heating sheets 16, at least two traction airbags 20 arranged between the airbag fixing plate 18 and the airbag pressing plate 19, and an air pump 21 further arranged inside the mounting cavity, where the air pump 21 is electrically connected to the control panel 12, and the two traction airbags 20 are connected to the air pump 21; and
specifically, the housing is formed by snap-fitting a face housing 10 and a bottom housing 11, the mounting cavity is arranged inside the housing, and one surface of the housing fits a human waist with a certain curvature, such that the surface thereof can be fitted on the human waist; the control panel 12 is fixedly arranged inside the mounting cavity, the control panel 12 is connected to the battery 13, and the battery 13 is a lithium battery capable of storing electricity and recharging; the first motor 14 and the second motor 15 are mounted in the housing, the first motor 14 and the second motor 15 are respectively connected to the control panel 12 and are controlled by the control panel 12 to start, output ends of both the first motor 14 and the second motor 15 are connected to eccentric wheels, and when working, the first motor 14 and the second motor 15 drive the eccentric wheels to rotate, where movement of the eccentric wheels causes the housing to vibrate, so as generate a massage effect on a human body; and to achieve a thermal therapy effect, two of the heating sheets 16 are mounted on the arc-shaped surface of the housing, the conductive adhesives 17 are mounted above the heating sheets 16, both the heating sheets 16 and the conductive adhesives 17 are electrically connected to the control panel 12, the heating sheets 16 are configured for generating heat to achieve the thermal therapy effect, and the conductive adhesives 17 are configured for conducting current to generate a pulsing effect on a human body.

The waist physiotherapy instrument is usually tied to the human waist. To ensure that the waist physiotherapy instrument better fits the human waist, the airbag fixing plate 18 is further mounted on a back face of the housing, a surface of the airbag fixing plate 18 opposite to the housing is connected to the airbag pressing plate 19, at least two of the traction airbags 20 are arranged between the airbag fixing plate 18 and the airbag pressing plate 19, the two traction airbags 20 are arranged on left and right sides respectively, the two traction airbags 20 are connected to the air pump 21, and the air pump 21 inflates the two traction airbags 20, such that the two traction airbags 20 expand, and the arc-shaped surface of the housing further presses against the human waist, which generates a traction sensation and enhances user experience.

The number of the traction airbags 20 can be determined based on actual needs and can be three or more.

To facilitate observation of a battery level and operating mode of the waist physiotherapy instrument, a lamp panel 23 is further arranged inside the mounting cavity, a plurality of LED lamps are arranged on the lamp panel 23 to indicate different information such as the battery level, mode, speed, intensity and the like. Lamp holes corresponding to the LED lamps are further formed in the arc-shaped surface of the housing, and light from the LED lamps penetrates through the lamp holes to facilitate observation by the user.

The air pump 21 is further connected to an air valve 22, the air valve 22 is fixed in the mounting cavity, an output end of the air valve 22 is connected to an air tube, and an end of the air tube away from the air valve 22 is connected to an input port of the corresponding traction airbag 20. To facilitate a connection, avoidance holes 24 are formed in the back face of the housing and the airbag fixing plate 18, and the air tube is connected to the input port of the corresponding traction airbag 20 through the avoidance holes 24.

To facilitate control of related functions by the user, the control panel 12 is further connected to a controller 25, and the controller 25 is configured for controlling the waist physiotherapy instrument to execute related functions.

To sum up, the physiotherapy instrument achieves a function of vibration massage through arrangement of the first motor 14 and the second motor 15, achieves effects of massage based on the thermal therapy and pulsing through arrangement of the heating sheets 16 and the conductive adhesives 17, and enhances the user experience through arrangement of the traction airbags 20, as a traction effect is generated during inflation and deflation. The present disclosure has a reasonably designed structure and diversified functions, and effectively meets different usage needs.

The present disclosure is not limited merely to what is described in the specification and the embodiments, such that additional advantages and modifications can be readily achieved by those skilled in the art. Without departing from the spirit and scope of the general concept as defined by the claims and the equivalents, the present disclosure is not limited to the specific details, representative apparatus, and illustrative examples as shown and described herein.

What is claimed is:

1. A multifunctional waist physiotherapy instrument, comprising: a housing, wherein a mounting cavity is arranged inside the housing, and a surface of the housing is arranged to be arc-shaped to adapt to a human waist; a control panel, a battery, a first motor, and a second motor that are fixedly arranged inside the mounting cavity, wherein the battery is electrically connected to the control panel, and the first motor and the second motor are respectively electrically connected to the control panel;
heating sheets arranged on an arc-shaped surface of the housing, and conductive adhesives mounted on the heating sheets, wherein the heating sheets are electrically connected to the control panel; and
an airbag fixing plate and an airbag pressing plate mounted on a surface of the housing opposite to the heating sheets, at least two traction airbags arranged between the airbag fixing plate and the airbag pressing plate, and an air pump further arranged inside the mounting cavity, wherein the air pump is electrically connected to the control panel, and the two traction airbags are connected to the air pump.

2. The multifunctional waist physiotherapy instrument according to claim 1, wherein a lamp panel is further arranged inside the mounting cavity, the lamp panel is electrically connected to the control panel, a plurality of LED lamps are arranged on the lamp panel, and lamp holes are formed in a surface of the housing corresponding to the lamp panel.

3. The multifunctional waist physiotherapy instrument according to claim 1, wherein
avoidance holes are formed in a back face of the housing provided with the airbag fixing plate and in the airbag fixing plate respectively, an air valve is further arranged inside the mounting cavity, the two traction airbags are respectively connected to the corresponding air valves through the avoidance holes, and the air valve is connected to the air pump.

4. The multifunctional waist physiotherapy instrument according to claim 1, wherein output ends of both the first motor and the second motor are connected to eccentric wheels.

5. The multifunctional waist physiotherapy instrument according to claim 1, wherein the control panel is further connected to a controller.
